(19) United States
(12) Patent Application Publication
(10) Pub. No.: US 2025/0190426 A1
(43) Pub. Date: Jun. 12, 2025

(54) SYSTEMS AND METHODS FOR TARGETED DATA DISCOVERY

(71) Applicant: OneTrust, LLC, Atlanta, GA (US)

(72) Inventors: Kevin Jones, Atlanta, GA (US); Saravanan Pitchaimani, Atlanta, GA (US); Subramanian Viswanathan, San Ramon, CA (US); Milap Shah, Bangalore (IN); Ramana Malladi, Atlanta, GA (US); Aadil Allidina, Atlanta, GA (US); Matthew Hennig, Atlanta, GA (US); Dylan D. Patton-Kuhl, Atlanta, GA (US); Jonathan Blake Brannon, Smyrna, GA (US)

(21) Appl. No.: 19/058,691

(22) Filed: Feb. 20, 2025

Related U.S. Application Data
(63) Continuation of application No. 18/469,428, filed on Sep. 18, 2023.
Application No. 18/469,428 is a continuation of application No. 17/370,650, filed on Jul. 8, 2021, now Pat. No. 11,797,528.
(60) Provisional application No. 63/049,268, filed on Jul. 8, 2020.

(51) Int. Cl. G06F 16/242; G06F 11/34; G06F 16/23; G06F 16/2457; G06F 16/25; G06N 20/00

(52) U.S. Cl. CPC G06F 16/2423; G06F 11/3409; G06F 16/2358; G06F 16/2457; G06F 16/258; G06N 20/00; G06F 2201/80

(57) ABSTRACT

Various embodiments provide methods, apparatus, systems, computing devices, computing entities, and/or the like for identifying targeted data for a data subject across a plurality of data objects in a data source. In accordance with one embodiment, a method is provided comprising: receiving a request to identify targeted data for a data subject; identifying a first data object using metadata for a data source that identifies the first data object as associated with a first targeted data type for a data portion from the request; identifying a first data field from a graph data structure of the first data object that identifies the first data field as used for storing data having the first targeted data type; and querying the first data object based on the first data field and the data for the first targeted data type to identify a first targeted data portion for the data subject.

### CROSS-REFERENCE TO RELATED APPLICATIONS

This application is a continuation of U.S. patent application Ser. No. 18/469,428, filed Sep. 18, 2023, which is a continuation of U.S. patent application Ser. No. 17/370,650, filed Jul. 8, 2021, which claims the benefit of U.S. Provisional Patent Application No. 63/049,268, filed Jul. 8, 2020, the disclosure of which is hereby incorporated herein by reference in its entirety.

### TECHNICAL FIELD

The present disclosure is generally related to a computational framework used for identifying targeted data found over multiple data sources.

### BACKGROUND

Many entities handling (e.g., collects, receives, transmits, stores, processes, shared, and/or the like) certain types of data that may be found over multiple data sources may be tasked with performing actions on the data that involve locating certain portions of the data over the multiple data sources. However, as the quantity of data increases over time, and/or as the number of systems that may be potentially handling data increases, as well as the number of data sources used in handling data increases, determining how particular data has been handled (e.g., collected, received, transmitted, stored, processed, shared, and/or the like) across all of the potential systems, data sources, and/or the like can be significantly difficult. Accordingly, a need exists in the art for meeting the technical challenges in identifying, locating, and managing data found over multiple data sources.

### SUMMARY

In general, embodiments of the present invention provide methods, apparatus, systems, computing devices, computing entities, and/or the like for identifying targeted data for a data subject across a plurality of data objects in a data source. In accordance with one aspect, a method is provided. In various embodiments, the method involves: receiving, by computing hardware, a request to identify targeted data for a data subject; identifying, by the computing hardware, a first data object from a plurality of data objects using metadata for a data source, wherein the metadata identifies the first data object as associated with a first targeted data type for a data portion from the request; identifying, by the computing hardware, a first data field from a graph data structure of the first data object, wherein the graph data structure of the first data object identifies the first data field as used for storing data having the first targeted data type; querying, by the computing hardware, the first data object based on the first data field and the data for the first targeted data type to identify a first targeted data portion for the data subject; determining, by the computing hardware, the first targeted data portion is associated with a second targeted data type; identifying, by the computing hardware, a second data object from the plurality of data objects using the metadata for the data source, wherein the metadata identifies the second data object as associated with the second targeted data type; identifying, by the computing hardware, a second data field from a graph data structure of the second data object, wherein the graph data structure of the second data object identifies the second data field as used for storing data in the second data object having the second targeted data type; querying, by the computing hardware, the second data object based on the second data field and the first targeted data portion associated with the second targeted data type to identify a second targeted data portion for the data subject; and performing a targeted data action based on the first targeted data portion or the second targeted data portion.

In addition, in particular embodiments, the method may involve determining that the first targeted data portion is associated with a third targeted data type for a second data source; identifying a third data object from the second data source using metadata for the second data source, wherein the metadata for the second data source identifies the third data object as associated with the third targeted data type; identifying a third data field from a graph data structure of the third data object, wherein the graph data structure of the third data object identifies the third data field as used for storing data in the third data object associated with the third targeted data type; and querying the third data object based on the third data field and the first targeted data portion associated with the third targeted data type to identify a third targeted data portion for the data subject, wherein the targeted data action is based on at least one of the first targeted data portion, the second targeted data portion, or the third targeted data portion.

Further, in particular embodiments, the method may involve generating the metadata for the data source by: scanning the data source to identify a plurality of targeted data types found in the data source, the plurality of targeted data types including the first targeted data type and the second targeted data type; performing a determination that the first targeted data type and the second targeted data type can be used to query the targeted data from the data source; and modifying, based on the determination, the metadata to include the first targeted data type and the second targeted data type. In some embodiments, scanning the data source to identify the plurality of targeted data types found in the data source may involve: identifying a plurality of data fields used for storing the targeted data in the plurality of data objects for the data source; processing combinations of data fields of the plurality of data fields using a machine learning model to generate an indication that each combination of the combinations of data fields are used for storing data associated with a common targeted data type; and identifying the plurality of targeted data types based on the plurality of data fields and the indication for each combination of the combinations of data fields. In some embodiments, determining that a targeted data type can be used to query the targeted data from the data source is based on the targeted data type being associated with multiple data fields found in the plurality of data objects for the data source.

In particular embodiments, the targeted data action comprises at least one of generating a location map for the targeted data that comprises a storage location for each of the first targeted data portion and the second targeted data portion, providing the first targeted data portion and the second targeted data portion for display on a graphical user interface to a user who submitted the request for the targeted data, or removing the first targeted data portion and the second targeted data portion from the data source. In addition, in particular embodiments, the request for the targeted data comprises a data subject access request, the data subject comprises an individual, the targeted data comprises personal data on the individual, and the data portion associated with the first targeted data type comprises at least one of a first name for the individual, a last name for the individual, a phone number for the individual, a username for the individual, an email address for the individual, a social security number for the individual, a date of birth for the individual, a postal code for the individual, or a street address for the individual.

In accordance with another aspect, a system comprising a non-transitory computer-readable medium storing instructions and a processing device communicatively coupled to the non-transitory computer-readable medium is provided. Accordingly, in various embodiments, the processing device is configured to execute the instructions and thereby perform operations comprising: receiving a request to identify targeted data for a data subject, wherein the request comprises a data portion associated with a first targeted data type; and responsive to receiving the request to identify the targeted data for the data subject: identifying a first data object from a plurality of data objects using metadata for a data source, wherein the metadata identifies the first data object as associated with the first targeted data type; identifying a first data field used for storing data in the first data object associated with the first targeted data type; identifying a first targeted data portion stored in the first data object based on the first data field and the data for the first targeted data type; identifying the first targeted data portion is associated with a second targeted data type; identifying a second data object from the plurality of data objects using the metadata for the data source, wherein the metadata identifies the second data object as associated with the second targeted data type; identifying a second data field used for storing data in the second data object associated with the second targeted data type; identifying a second targeted data portion based on the second data field and the first targeted data portion; and causing performance of a targeted data action based on at least one of the first targeted data portion or the second targeted data portion.

In particular embodiments, the operations further comprise: identifying a third targeted data portion stored in the first data object based on the first data field and the data for the first targeted data type; identifying the third targeted data portion being associated with a third targeted data type for a second data source comprising a plurality of data objects; identifying a third data object from the plurality of data objects for the second data source using metadata for the second data source, wherein the metadata for the second data source identifies the third data object as associated with the third targeted data type; identifying a third data field used for storing data in the third data object associated with the third targeted data type; and identifying a fourth targeted data portion based on the third data field and the third targeted data portion, wherein the targeted data action based on at least one of the first targeted data portion, the second targeted data portion, the third targeted data portion, or the fourth targeted data portion.

In addition, in particular embodiments, the operations further comprise: scanning the data source to identify a plurality of targeted data types found in the data source, the plurality of targeted data types including the first targeted data type and the second targeted data type; performing a determination that the first targeted data type and the second targeted data type can be used to query the targeted data from the data source; and modifying, based on the determination, the metadata to include the first targeted data type and the second targeted data type. In some embodiments, scanning the data source to identify the plurality of targeted data types found in the data source is performed by: identifying a plurality of data fields used for storing the targeted data in the plurality of data objects for the data source; processing combinations of data fields of the plurality of data fields using a machine learning model to generate an indication that each combination of the combinations of data fields are used for storing data associated with a common targeted data type; and identifying the plurality of targeted data types based on the plurality of data fields and the indication for each combination of the combinations of data fields.

In some embodiments, the targeted data action comprises providing the first targeted data portion or the second targeted data portion for display on a graphical user interface to a user who submitted the request for the targeted data. In some embodiments, the targeted data action comprises removing at least one of the first targeted data portion or the second targeted data portion from the data source. In some embodiments, the request for the targeted data comprises a data subject access request, the data subject comprises an individual, and the targeted data comprises personal data on the individual.

In accordance with yet another aspect, a non-transitory computer-readable medium is provided. Accordingly, in various embodiments, the non-transitory computer-readable medium includes program code that is stored thereon, the program code executable by one or more processing devices for performing operations comprising: identifying a first data object from a plurality of data objects for a data source, wherein the first data object is associated with a first targeted data type associated with a data portion received in a request to identify targeted data for a data subject; identifying a first targeted data portion stored in the first data object; identifying the first targeted data portion is associated with a second targeted data type; identifying a second data object from the plurality of data objects for the data source, wherein the second data object is associated with the second targeted data type; identifying a second targeted data portion stored in the second data object; and causing performance of a targeted data action based on at least one of the first targeted data portion or the second targeted data portion.

In particular embodiments, the operations further comprising: identifying a third targeted data portion stored in the first data object; identifying the third targeted data portion is associated with a third targeted data type for a second data source comprising a plurality of data objects; identifying a third data object from the plurality of data objects for the second data source, wherein the second data source identifies the third data object is associated with the third targeted data type; and identifying a fourth targeted data portion stored in the third data object, wherein the targeted data action is based on at least one of the first targeted data portion, the second targeted data portion, the third targeted data portion, or the fourth targeted data portion.

In addition, in particular embodiments, the operations further comprise: scanning the data source to identify a plurality of targeted data types found in the data source, the plurality of targeted data types including the second targeted data type; performing a determination that the second targeted data type can be used to query the targeted data from the data source; and modifying, based on the determination, the metadata to include the second targeted data type. In some embodiments, scanning the data source to identify the plurality of targeted data types found in the data source is performed by: identifying a plurality of data fields used for storing the targeted data in the plurality of data objects for the data source; processing combinations of data fields of the plurality of data fields using a machine learning model to generate an indication that each combination of the combinations of data fields are used for storing data associated with a common targeted data type; and identifying the plurality of targeted data types based on the plurality of data fields and the indication for each combination of the combinations of data fields.

In some embodiments, the targeted data action comprises providing at least one of the first targeted data portion or the second targeted data portion for display on a graphical user interface to a user who submitted the request for the targeted data. In some embodiments, the targeted data action comprises removing at least one of the first targeted data portion or the second targeted data portion from the data source.

### BRIEF DESCRIPTION OF THE DRAWINGS

In the course of this description, reference will be made to the accompanying drawings, which are not necessarily drawn to scale, and wherein:

FIG. 1 is a flowchart of a process for identifying targeted data found in data sources in accordance with various embodiments of the present disclosure;

FIG. 2 provides an example of graphical data structures of data objects that may be used in accordance with various embodiments of the present disclosure;

FIG. 3 is a flowchart of a process for generating a location map for a data source in accordance with various embodiments of the present disclosure;

FIG. 4 is a flowchart of a process for identifying the locations for a known queryable targeted data type in accordance with various embodiments of the present disclosure;

FIG. 5 provides another example of a graphical data structure of a data object that may be used in accordance with various embodiments of the present disclosure; and

FIG. 6 provides another example of a graphical data structure of data objects that may be used in accordance with various embodiments of the present disclosure.

FIG. 7 is a flowchart of a process for recording metadata for a data source in accordance with various embodiments of the present disclosure;

FIG. 8 is a flowchart of a process flow for identifying targeted data types eligible for querying a data source in accordance with various embodiments of the present disclosure;

FIG. 9 is a block diagram illustrating an exemplary system architecture that may be used in accordance with various embodiments of the present disclosure; and

FIG. 10 is a schematic diagram of a computing entity that may be used in accordance with various embodiments of the present disclosure.

### DETAILED DESCRIPTION

Various embodiments for practicing the technologies disclosed herein are described more fully hereinafter with reference to the accompanying drawings, in which some, but not all embodiments of the technologies disclosed are shown. Indeed, the embodiments disclosed herein are provided so that this disclosure will satisfy applicable legal requirements and should not be construed as limiting or precluding other embodiments applying the teachings and concepts disclosed herein. Like numbers in the drawings refer to like elements throughout.

### Various Embodiments and Technical Contributions Thereof

Many entities handling (e.g., collects, receives, transmits, stores, processes, shared, and/or the like) certain types of data that may be found over multiple data sources may be tasked with performing actions on the data that involve locating certain portions of the data over the multiple data sources. For example, an entity that handles sensitive and/or personal information associated with particular individuals, such as personally identifiable information (PII) data, that is found over multiple data sources may be subject to having to retrieve and perform actions on certain portions of the sensitive and/or personal data for a particular individual (e.g., data subject) upon request by the particular individual, such as reporting the sensitive and/or personal data stored for the individual over the multiple data sources, updating the sensitive and/or personal data for the individual, and/or deleting the sensitive and/or personal data from the multiple data sources.

As the quantity of data increases over time, and/or as the number of systems that may be potentially handling data increases, as well as the number of data sources used in handling data increases, determining how particular data has been handled (e.g., collected, received, transmitted, stored, processed, shared, and/or the like) across all of the potential systems, data sources, and/or the like can be difficult. Accordingly, discovering particular data (e.g., targeted data) across multiple systems, data sources, and/or the like may become even more challenging when each of the systems, data sources, and/or the like may use their own, possibly unique, process of identifying the data subject associated with the particular data. That is to say, where different mechanisms, procedures, techniques, and/or the like of identifying a data subject are used across multiple systems, data sources, and/or the like, locating targeted data associated with a particular data subject may not be feasible by simply using a portion (e.g., a single piece) of information (e.g., username) associated with the particular data subject.

Accordingly, various embodiments of the present disclosure overcome many of the technical challenges associated with handling targeted data as mentioned above. Specifically, various embodiments of the disclosure are directed to a computational framework configured for connecting to one or more data sources that may handle targeted data for a particular data subject. For example, such data source(s) may include, but are not limited to, one or more file repositories (structured and/or unstructured), one or more data repositories, one or more databases, one or more enterprise applications, one or more mobile applications (“apps”), cloud storage, local storage, and/or any other type of system that may be configured to handle targeted data. Here, various embodiments of the framework are configured to analyze at least a portion of the data stored on the one or more data sources to identify one or more portions of targeted data and label the one or more portions of targeted data accordingly. Here, a “portion” of targeted data may involve an identifiable piece, segment, section, and/or the like of the targeted data. For example, targeted data that represents personal data for a data subject that is an individual may include “portions” of personal data for the individual such as a first name, a last name, a phone number, a username, an email address, a social security number, a date of birth, a postal code, or a street address for the individual.

In addition, embodiments of the framework may then record the location of each of the one or more portions of targeted data and/or the one or more data sources on which each of the one or more portions of targeted data were discovered, as well as the manner of identification used to identify each of the one or more portions of targeted data. Accordingly, in particular embodiments, the framework may store any such information as metadata that can then be used in locating the particular targeted data. For example, embodiments of the framework may use the information to respond to a data subject access request (a “DSAR”), to comply with various requirements (e.g., legal, regulatory, standards, etc.), to mine legacy systems for targeted data, to create a map of where targeted data may be stored, to identify targeted data that may need to be modified, and/or the like.

In analyzing the data on one or more various data sources, the framework is configured in various embodiments to determine whether a particular portion of targeted data (a particular targeted data portion) on a first data source corresponds to particular portion of targeted data on a second data source. Here, in particular embodiments, the framework is configured to compare the particular portions of targeted data by performing, for example, a text string comparison, to determine if the two portions of targeted data represent a same targeted data type. For instance, in some embodiments, the framework may be configured to compare identifiers of the particular portions of targeted data to determine if they correspond to a same targeted data type. Accordingly, in various embodiments, the framework may be configured to use artificial intelligence such as one or more machine learning models and/or big data techniques to perform a sophisticated analysis to determine whether the particular portions of targeted data correspond to a particular targeted data type. Such an analysis may be helpful in some embodiments when two particular portions of targeted data may have different labels and/or identifiers and/or may be stored in different formats but may actually represent a same type of targeted data (e.g., email address, phone number, etc.). Once the portions of targeted data are identified and/or matched to a corresponding targeted data type in particular embodiments, the framework may involve storing information in the form of metadata reflecting the identification and/or matching of targeted data type for future use.

Accordingly, in a particular embodiment, the framework may also be configured to identify (e.g., tag) one or more targeted data types in the metadata to indicate that the particular targeted data type(s) can be used to query one or more associated data sources. In some embodiments, the framework may be configured to also, or instead, identify (e.g., in metadata) one or more elements such as fields associated with storing data (e.g., value, attribute, and/or the like) for targeted data types at a particular data source to indicate that the respective field(s) may contain data that can be used to query that data source. As detailed further herein, the framework is configured in various embodiments to then use the identified targeted data types eligible for querying, for example, in future attempts (e.g., requests) to locate particular targeted data stored in a particular data source for a particular data subject.

Accordingly, various embodiments of the disclosure provided herein are more effective, efficient, timely, accurate, and faster in identifying targeted data from large volumes of data, spread over various data sources, than conventional practices, systems, and infrastructures used in many industries today. In addition, various embodiments of the disclosure provided herein can facilitate the identification and/or documentation of targeted data present within large volumes of data, spread over various data sources, as well as facilitate the retrieval of targeted data for a data subject, that could not normally be carried out using conventional practices, systems, and infrastructures. Further, various embodiments of the disclosure can carry out data processing that cannot be feasibly performed by a human, especially when such data processing involves large volumes of data. This is especially advantageous when data processing must be carried out over a reasonable timeframe to allow for relevant observations to be gathered from the data and/or relevant operations to be performed on the data. In doing so, various embodiments of the present disclosure make major technical contributions to improving the computational efficiency and reliability of various automated systems and procedures for processing large volumes of data to identify targeted data. This in turn translates to more computationally efficient software systems. Further detail is now provided for different aspects of various embodiments of the disclosure.

It is noted that reference is made to targeted data throughout the remainder of the application. However, targeted data is not necessarily limited to information that may be configured as personal and/or sensitive in nature but may also include other forms of information that may be of interest. For example, targeted data may include data on a particular subject of interest, such as a political organization, manufactured product, current event, and/or the like. Further, targeted data may not necessarily be associated with an individual but may be associated with other entities such as a business, organization, government, association, and/or the like.

### Targeted Data Discovery

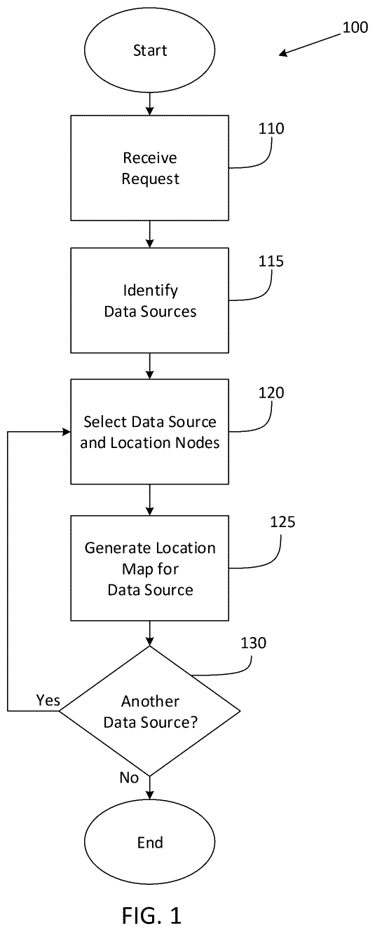

Turning now to FIG. 1, additional details are provided regarding a targeted data discovery process 100 for discovering (e.g., querying) targeted data found in one or more data sources for a data subject in accordance with various embodiments of the disclosure. Accordingly, the process 100 may be implemented in various embodiments as suitable program code executed on computing hardware as described herein.

As an example, a particular user may submit a DSAR requesting a copy of targeted data in the form of personal data associated with a particular data subject indicated by the DSAR. In this example, the DSAR may include the particular data subject's first name, last name, and email address. While this example highlights retrieving personal data in the context of fulfilling a DSAR for a particular data subject, note that other examples may also or alternatively involve locating targeted data in response to a need to comply with one or more various requirements (e.g., legal, regulatory, standards, etc.), mining legacy systems for targeted data, creating a map of where targeted data may be stored, identifying targeted data that may need to be modified, and/or the like.

Here, the entity handling the targeted data may have the targeted data associated with the particular data subject in separate data sources. For instance, a first data source may be a customer database that stores the username of the particular data subject, along with the particular data subject's email address, first name, last name, social security number, postal code (e.g., zip code), and street address. The first data source may (e.g., only, or most efficiently) be searchable by email address. A second data source may be a certified drivers database that stores the particular data subject's driver's license record and social security number. The second data source may (e.g., only, or most efficiently) be searchable by social security number. Thus, in this example, the entity may not be able to use these particular portions of targeted data to access every relevant data source (e.g., customer database and certified drivers database). Therefore, in order to fully respond to the DSAR, the entity may retrieve targeted data from all relevant data sources via the process 100 shown in FIG. 1.

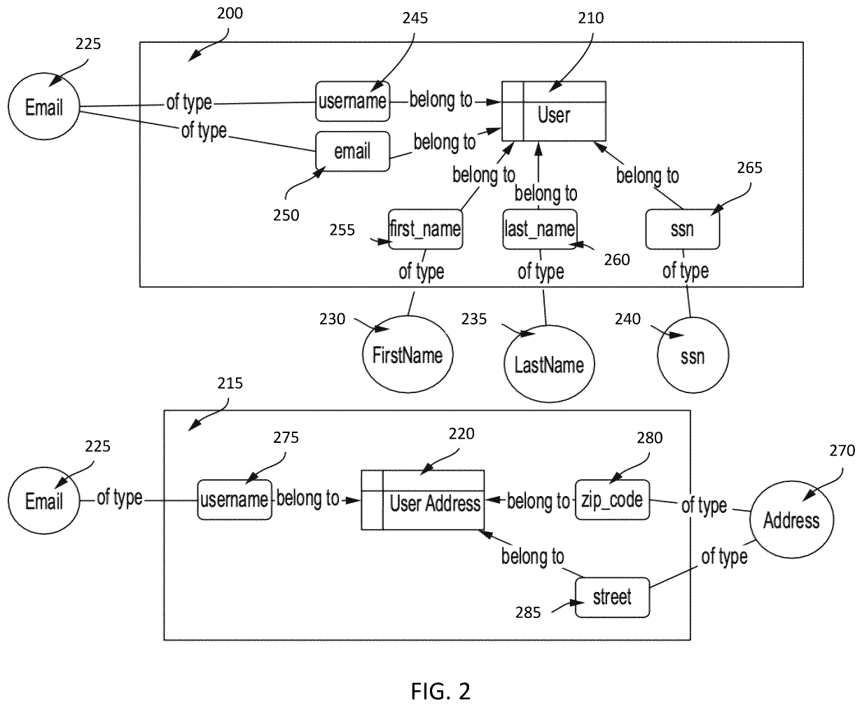

Briefly turning to FIG. 2, graph data structures (as described further herein) are provided based on the example. Here, the first graph data structure is provided for the data object “User” 210 and a second graph data structure 215 is provide for the data object “UserAddress” 220. The first graph data structure 200 represents that the targeted data types associated with the data object “User” 210 are “Email” 225, “FirstName” 230, “LastName” 235 and “ssn” 240. In addition, the first graph data structure “User” 200 represents the different fields within the data object that may use each targeted data type. Specifically, the targeted data type “Email” 225 may be used in populating the data fields “username” 245 and “email” 250, the targeted data type “FirstName” 230 may be used in populating the data field “first_name” 255, the targeted data type “LastName” 235 may be used in populating the data field “last_name” 260, and the targeted data type “ssn” 240 may be used in populating the data field “ssn” 265.

Likewise, the second graph data structure 215 represents that the targeted data types associated with the data object “UserAddress” 220 are “Email” 225 and “Address” 270. Accordingly, the second graph data structure 215 represents the targeted data type “Email” 225 can be used to populate the data field “username” 275 for the data object “UserAddress” and the targeted data type “Address” 270 can be used to populate the data fields “zip_code” 280 and “street” 285.

Accordingly, the targeted data discovery process 100 involves receiving the request (e.g., DSAR) at Step 110 and determining one or more data sources that are accessible using one or more portions of targeted data that are included in the request at Step 115. For example, in particular embodiments, the process 100 involves accessing metadata for each of the available data sources to identify whether a targeted data type associated with a data source is associated with one or more portions of targeted data that are included in the request that can be used in querying the data source. If not, then a notification (message) may be returned to the requesting user indicating that additional targeted data is needed to complete the request.

However, if one or more data sources are identified, then the targeted data discovery process 100 continues with selecting a first data source and corresponding location nodes at Step 120. Here, in particular embodiments, the location nodes may represent the different data objects used within the data source associated with targeted data types found in the data source. For example, the data source may be a database and the various data objects may be the different tables found in the database used for storing data. In some embodiments, the process 100 may involve identifying the location nodes for the data source using metadata generated for the data source as described further herein.

In some embodiments, the targeted data discovery process 100 may involve identifying known targeted data types that may be used for querying for the request. Accordingly, the process 100 may involve identifying such targeted data types as those targeted data types that are eligible to be used for querying targeted data from the data source and for which there are known data (e.g., values, attributes, and/or the like). For instance, in the example, the request is received along with an email address for the data subject. Here, the targeted data discovery process 100 may involve determining that the email address is associated with the targeted data type “Email” 225 that is eligible for querying the data source and therefore, the targeted data type “Email” 225 is a known queryable targeted data type for the data source. As a result, the process 100 may continue by using this targeted data type 225 to perform an initial query of the data source.

As the targeted data discovery process 100 continues with performing one or more queries using known queryable targeted data types, the process 100 may result in discovering data (e.g., values, attributes, and/or the like) for additional targeted data types that can then be used to conduct further queries for additional targeted data. For example, the initial query may have returned targeted data for the data subject is the form of the data subject's social security number. Here, metadata may indicate the data field used in storing the social security number is associated with a targeted data type that can be used in querying the data source. Therefore, the targeted data discovery process 100 may continue by performing an additional query of the data source using the data subject's social security number to retrieve additional targeted data for the data subject. As a result, the process 100 in various embodiments can allow for querying targeted data from the data source that may not have been necessarily discoverable using the portion(s) of targeted data provided along with the request.

Further, in some embodiments, the targeted data discovery process 100 may involve setting an indicator (e.g., a flag) for each location node representing that an associated data object has not yet been queried to obtain targeted data to fulfill the request. As described further herein, the indicator is then set to represent the associated data object has been queried based at least in part on the data object being queried for targeted data to fulfill the request. Accordingly, in these embodiments, such a configuration may prevent having to query a data object multiple times for targeted data to fulfill the request.

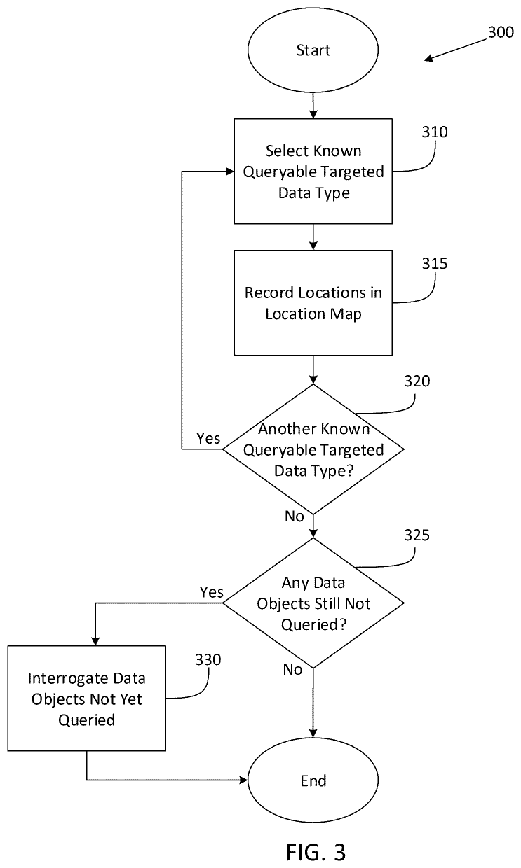

The targeted data discovery process 100 continues with generating a location map representing the locations where targeted data is found in the data source at Step 125. For instance, this particular step may be performed in various embodiments via a generate location map process as detailed in FIG. 3. Accordingly, the generate location map process involves performing one or more queries using known queryable targeted data types to locate targeted data found in the data source and record the locations for the targeted data in the location map. In addition, the generate location map process is carried out in some embodiments to identify additional known queryable targeted data types and perform additional queries accordingly. Furthermore, the generate location map process is carried out in some embodiments to identify data (e.g., a value, attribute, and/or the like) for identified targeted data types.

In various embodiments, the location map includes the location (e.g., location in a computer memory, data structure, data model, and/or the like) of the various targeted data types found in the data source along with data for each targeted data type. Thus, the location map can then be used in providing an answer (e.g., output) to the request. At this point, the targeted data discovery process 100 continues with determining whether another data source is accessible using known targeted data at Step 130. Here, in particular embodiments, the process 100 may involve identifying those data sources that are accessible based at least in part on the targeted data, not only provided in the request, but also those data sources that are now accessible based at least in part on targeted data identified from the data source just processed. As a result, targeted data may be discovered in data sources not originally accessible using the targeted data provided in the request. If additional data sources are accessible, then the process 100 involves returning to Step 120, selecting the next data source, and generating a location map for the newly selected data source as just described.

It is noted that depending on the embodiment, the targeted data discovery process 100 may be carried out to generate a separate location map for each data source or one location map for all of the data sources. In addition, in particular embodiments, the targeted data discovery process 100 (or some other process) may involve performing one or more targeted data actions based at least in part on the targeted data discovered (e.g., queried) from the one or more data sources. For example, in some embodiments, the targeted data action may involve returning results for the request that contain the targeted data discovered from the one or more data sources. For instance, the results may be provided for display on a graphical user interface to the user.

In other embodiments, the targeted data action may involve one or more automated processes that make use of the targeted data. For instance, one such automated process may involve cleansing (removing) the targeted data from the one or more data sources for the data subject. Here, for example, a data subject may have opted out of having his or her targeted (e.g., personal) data stored by an e-commerce entity on the entity's website. As a result, a request to have the data subject's targeted data may be submitted and the targeted data discovery process 100 (or some other process) may be performed to remove any targeted data discovered for the data subject in the data source(s) being utilized by the e-commerce entity. In another example, an automated process may involve identifying one or more potential candidates for a clinical trial to be conducted for a new drug. Here, the targeted data discovery process 100 (or some other process) may be carried out to identify such candidates using criteria based at least in part on targeted data involving the candidates' medical histories discovered through data source(s) used by one or more healthcare providers. Those of ordinary skill in the art can envision other automated processes that may be carried out based at least in part on discovered targeted data in light of this disclosure.

### Generate Location Map

Turning now to FIG. 3, additional details are provided regarding a generate location map process 300 for generating a location map for a data source in accordance with various embodiments of the disclosure. Accordingly, the process 300 may be implemented in various embodiments as suitable program code executed on computing hardware as described herein.

The generate location map process 300 begin with selecting a known queryable targeted data type at Step 310. In particular embodiments, a known queryable targeted data type is a targeted data type that is eligible for querying a data source in which data (value, attribute, and/or the like) is known for the targeted data type. For instance, as noted in the example involving the DSAR, the request was received having an email address for the data subject. Accordingly, the metadata for the data source may identify the targeted data type “Email” 225 as eligible to query the data source that corresponds to the email address provided in the request. Therefore, the targeted data type “Email” 225 may be identified as a known queryable targeted data type for the data source.

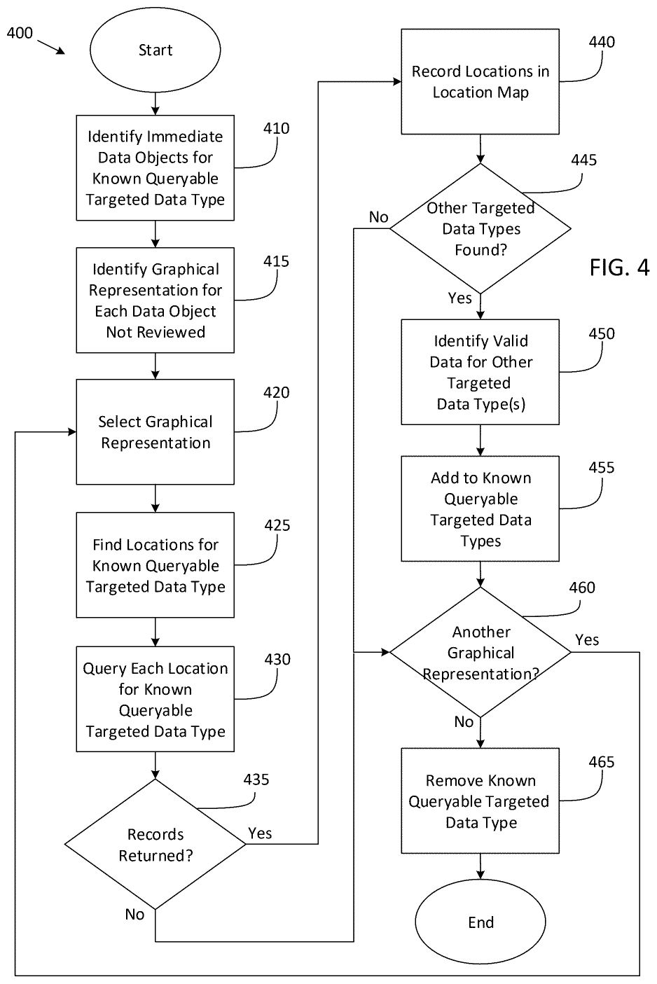

The generate location map process 300 continues with recording one or more locations for targeted data based at least in part on the known queryable targeted data type in the location map at Step 315. Accordingly, in particular embodiments, the generate location map process 300 is carried out by performing this particular step via an identify locations process as described in FIG. 4. As detailed further herein, the identify locations process involves performing one or more queries based at least in part on the known queryable targeted data type to discover (identify) locations of targeted data found in the data source. The identify locations process continues by recording the locations of the discovered targeted data in the location map. In addition, in particular embodiments, the identify locations process is carried out to identify valid data (e.g., values, attributes, and/or the like) for each discovered targeted data (if not already known), as well as identify whether each of the discovered targeted data is associated with a targeted data type that is eligible to use in querying the data source that has not already been identified. Such targeted data types may then be identified as known queryable targeted data types that can be used to conduct further queries for targeted data.

At this point, the generate location map process 300 continues with determining whether another known queryable targeted data type is available for the data source at Step 320. If so, then the process 300 involves returning to Step 310, selecting the next known queryable targeted data type, and recording one or more locations based at least in part on the newly selected known queryable targeted data type as previously described.

The generate location map process 300 then continues with determining whether every data object found in the data source and used for storing targeted data has been queried for the request at Step 325. In particular embodiments, such a determination may be made based at least in part on the data objects represented in the location nodes for the data source. As previously noted, each data object may be associated with an indicator that represents whether the particular data object has been queried for the request. Therefore, if one or more data objects are found in the location nodes with indicators representing the data objects have not been queried, then the generate location map process 300 involves interrogating the data objects that have not yet been queried at Step 330.

Accordingly, in various embodiments, the generate location map process 300 may involve performing this step by determining whether data for any of the targeted data types found in the location map can be used in querying the data objects that have not yet been queried. For example, a new field may have been added to a data object that represents a targeted data type after the metadata was generated for the data object. Therefore, the metadata may not reflect the field as being used to store targeted data. Thus, even though the metadata may not identify the targeted data type associated with the new field as a data type eligible for querying the data source, the associated targeted data type may be used in querying the data object. If a particular data object cannot be queried, then the generate location map process 300 in some embodiments may be carried out to generate some type of error message indicating such.

### Identify Locations

Turning now to FIG. 4, additional details are provided regarding an identify locations process 400 for identifying the locations for a known queryable targeted data type in accordance with various embodiments of the disclosure. Accordingly, the process 400 may be implemented in various embodiments as suitable program code executed on computing hardware as described herein.

The identify locations process 400 begins with identifying the immediate data objects in the data source for the known queryable targeted data type at Step 410. Here, in particular embodiments, a first search is performed to traverse one or more graph data structures for the data source using the known queryable targeted data type as a start node to identify the immediate data objects found in the data source for the known queryable targeted data type. For example, returning to FIG. 2, a first search may be performed on the two graph data structures 200, 215 using the known queryable targeted data type “Email” 225 to identify the data objects “User” and “UserAddress” 210, 220.

Next, the identify locations process 400 continues with identifying the graph data structures for each data object that has not yet been queried for targeted data based at least in part on the request at Step 415 and selects one of the graph data structures at step 420. Accordingly, in particular embodiments, the identify locations process 400 may determine whether a data object has already been queried based at least in part on the indicator set for the data object for the location nodes for the data source. The process 400 then continues by finding the locations of the queryable targeted data type in the data object based at least in part on the graph data structure at Step 425. Accordingly, in particular embodiments, the locations may identify what data fields are found in the data object that are populated with data associated with the known queryable targeted data type. Therefore, returning to FIG. 2, the locations may be identified involving the data fields “username” 245 and “email” 250 from the graph data structure 200 for the known queryable targeted data type “Email” 225.

At this point, the identify locations process 400 continues with querying the data source based at least in part on each identified location at Step 430. Thus, for the example involving FIG. 2, two queries may be performed. A first query based at least in part on the data field “username” 245 and a second query based at least in part on the data field “email” 250. For instance, the identify locations process 400 may involve querying the data source using:
SELECT ID, EMAIL, FIRST_NAME, LAST_NAME, SSN FROM USER WHERE USERNAME=“email address provided in request” LIMIT 100; and
SELECT ID, USERNAME, FIRST_NAME, LAST_NAME, SSN FROM USER WHERE EMAIL=“email address provided in request” LIMIT 100;

The identify locations process 400 involves determining whether each of the queries has returned records at Step 435. If a query returns one or more records (e.g., is not empty), then the process 300 continues with recording the location for the known targeted data type against the associated data field in the location map for the data source at Step 440.

Accordingly, in particular embodiments, the identify locations process 400 continues with determining whether the one or more queries performed for the known queryable targeted data type has identified data fields associated with other targeted data types at Step 445. Here, the metadata may be referenced for the data object in identifying any data fields that may be used in storing data for a targeted data type. If so, then valid data is identified (e.g., values, attributes, and/or the like) for each of the other targeted data types at Step 450.

Accordingly, in particular embodiments, the identify locations process 400 may be carried out to identify valid data for a particular targeted data type based at least in part on the data returned from the one or more queries. For example, in some embodiments, valid data may be identified for another targeted data type based at least in part on:
1. If the data field associated with the known queryable data type is used as a primary key for one of the data objects, then use the data returned in the query performed for that data object as valid data for the other targeted data type;
2. Else if a single record is returned for all the queries, then use the data returned in the single record as valid data for the other targeted data type;
3. Else if more than one record is returned for all the queries and the data is the same in each of the records, then use the data returned in the records as valid data for the other targeted data type;
4. Else if one of the queries returns a single record and the other queries return more than one record, then use the data returned in the single record as valid data for the other targeted data type;
5. Else generate an error message.

In addition, in various embodiments, the identify locations process 400 may involve determining whether each of the other targeted data types is a targeted type that is eligible for querying the data source, and if so, then the other targeted data type may be added as a known queryable targeted data type at Step 455. Accordingly, the identify locations process 400 may be performed to only add the other targeted data type as a known queryable targeted data type if valid data is identified for the other targeted data at Step 450.

For example, returning to FIG. 2, two queries performed on the data object “User” 210 returns fields (“first_name” 255, “last_name” 260, and “ssn” 265) that are associated with targeted data types. Therefore, valid data may be identified based at least in part on the data returned in the queries for each of the fields. At this point, the identify locations process 400 may continue with determining that the targeted data type associated with the field “ssn” 265 is a targeted data type that is eligible for querying the data source and adds the targeted data type as a known queryable targeted data type if valid data is identified for the targeted data type. Thus, as a result of adding the targeted data type as a known queryable targeted data type, one or more further queries may be carried out to discover additional targeted data found in the data source (and/or other data sources).

At this point the identify locations process 400 involves identifying (e.g., flagging) the data object associated with the graph data structure as queried and determines whether another graph data structure is associated with the known queryable targeted data type at Step 460. Accordingly, in particular embodiments, the data object is identified as queried so that the data object is not queried again. In addition, note that the graph data structure in the example represents a single data object. However, in some embodiments, a graph data structure may represent more than one data object. If another graph data structure is determined to be associated with the known queryable targeted data type, then the process involves returning to Step 720, selecting the next graph data structure associated with the known queryable targeted data object, and performing the steps just described for the newly selected graph data structure. For instance, returning to the example shown in FIG. 2, the steps just described are performed on the graph data structure 215 for the data object “UserAddress” 220. As a result, locations are identified to be added to the locations map for the targeted data type “Address” 270. Here, data for this particular targeted data type 270 is stored in the data fields “zip_code” 280 and “street” 285.

The identify locations process 400 continues with identifying (e.g., flagging) the known queryable targeted data type as used at Step 465. Accordingly, in particular embodiments, the known queryable targeted data type is identified as used so that the queryable targeted data type is not used again in conducting further queries for targeted data on the data source. However, it is noted that in some instances, the identify locations process 400 may involve perform a re-traversal on the graph data structure using the known queryable targeted data type before identifying the known queryable targeted data type as used because not all data objects associated with the known queryable targeted data type may not have been identified during the original traversal.

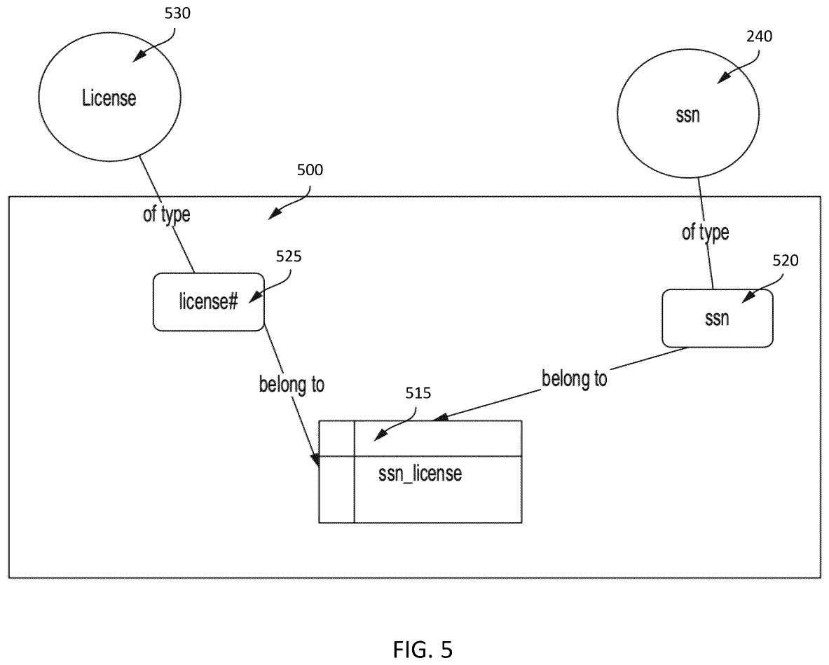

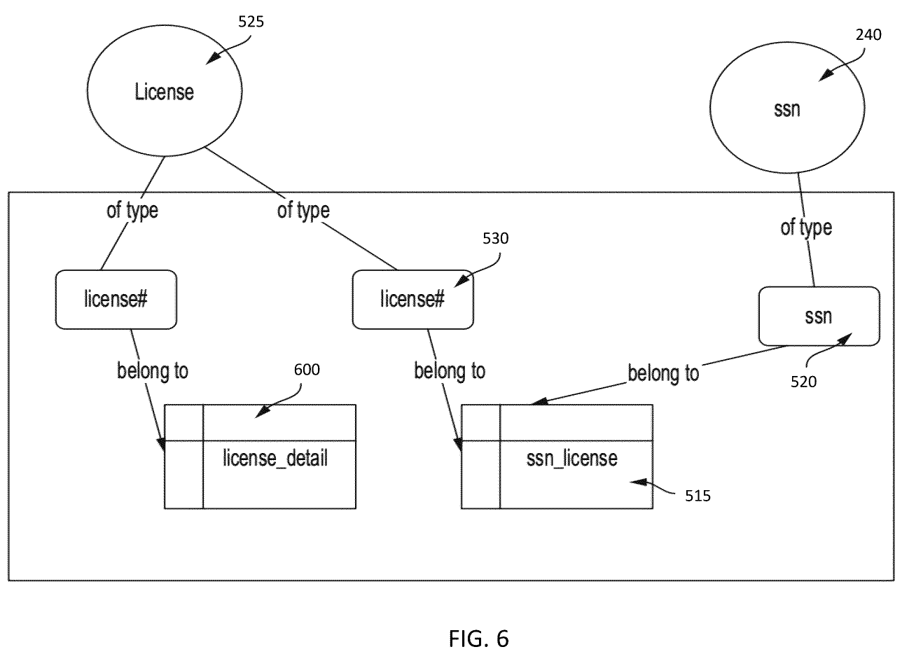

The identify locations process 400 may be carried out in various embodiments to process each of the known queryable targeted data types for a data source to further identify and gather targeted data for the data source. For instance, as noted above with respect to FIG. 2, carrying out the identify locations process 400 may identify the targeted data type “ssn” 240 as an additional known queryable targeted data type. As a result, this particular targeted data type 240 may then be used to further identifying locations of targeted data found in the data source or another data source (e.g., certified drivers database) for the data subject. For instance, turning now to FIG. 5, the identify locations process 400 may involve identifying a graph data structure 500 via the metadata for the data source or another data source for the data object “ssn_license” 515 found in the data source or another data source that has a data field “ssn” 520 associated with the known queryable targeted data type “ssn” 240. Accordingly, the identify locations process 400 may identify the graph data structure 500 and identify a data field “license #” 525 used for storing data associated with a targeted data type “License” 530. The identify locations process 400 may identify valid data for the targeted data type “License” 530, as well as determine the targeted data type “License” 530 is a targeted data type eligible for querying. As a result of carrying out the identify locations process 400, the targeted data type “License” 530 may be added as a known queryable targeted data type that can then be used in identifying locations of additional targeted data found in the data source and/or another data source for the data subject. This is further shown in FIG. 6, where the known queryable targeted data type “License” 530 may then be used to find further targeted data that may be stored in a data object “license_detail” 600 in the data source or another data source. Generate Metadata

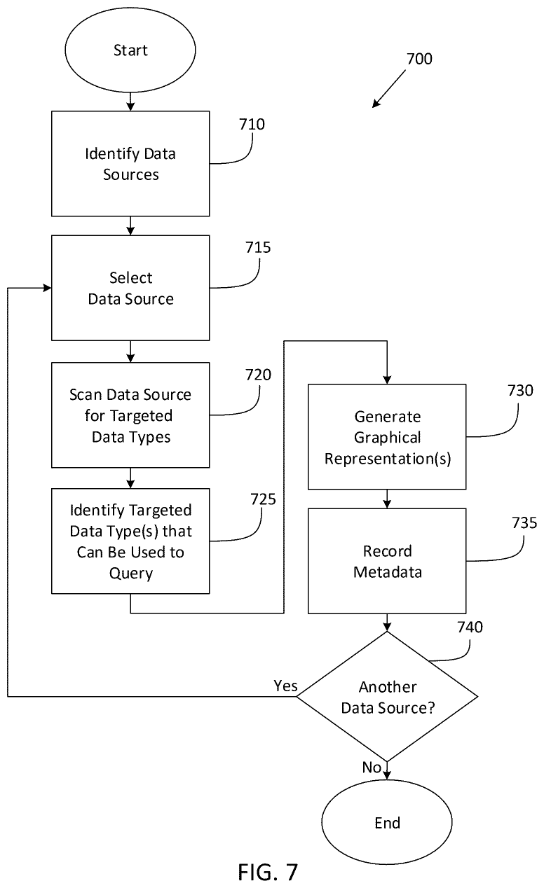

Turning now to FIG. 7, additional details are provided regarding a generate metadata process 700 flow for generating metadata for one or more data sources in accordance with various embodiments of the disclosure. In particular embodiments, the process 700 involves scanning each of the one or more data sources and generating metadata for the data source(s). In particular embodiments, the metadata may include one or more graph data structures providing a map of the targeted data that is stored in and/or otherwise handled at a data source, along with information on parameters (e.g., one or more targeted data types) that can be used to access the targeted data stored on the data source. Accordingly, the process 700 may be implemented in various embodiments as suitable program code executed on computing hardware as described herein.

Depending on the embodiment, the generate metadata process 700 may involve generating metadata for the one or more data sources before receiving a request to retrieve targeted data associated with a particular data subject. For example, the generate metadata process 700 may be carried out to generate the metadata based on the data sources being initially configured, a data subject being added to one or more of the data sources, data stored on one or more of the data sources is updated, and/or the like. In particular embodiments, the generate metadata process 700 may be carried out to generate the metadata on a regular (e.g., periodic) basis and/or in response to one or more events (e.g., regular data mining, integration of a legacy system, implementation of a new regulation, etc.). In some embodiments, the generate metadata process 700 may be carried out to generate the metadata in response to receiving a request for targeted data associated with a particular data subject.

Turning now to FIG. 7, the generate metadata process involves identifies the one or more data sources at Step 710. In particular embodiments, the one or more data sources may be identified based at least in part on the general type of data being targeted. For example, if the type of data is personal data, the generate metadata process 700 may identify all of the data sources used by an entity in handling personal data for individuals. For example, the entity may be an organization engaged in e-commerce. Here, the entity may store various data on customers such as names, mailing addresses, telephone numbers, credit card information, and/or the like. Such data is typically viewed as personal data. The entity may store the data on various data sources. For example, the entity may store customers' names, mailing addresses, and telephone numbers on a data source (e.g., database) used by a shipping department and credit card information on a separate data source (e.g., database) used by a department that processes purchases made online. Therefore, in this example, the generate metadata process 700 may identify that two data sources used by the shipping department and the department processing online purchases via metadata descripting the purpose of the data sources and/or the types of data stored in the data sources as data sources used in storing personal data. Here, depending on the embodiment, information used in identifying the one or more data sources may be provided, accessed, retrieved, and/or the like from one or more systems, computing entities, storage mediums, and/or the like.

The generate metadata process 700 continues with selecting one of the data source(s) at Step 715 and scanning the selected data source for targeted data types at Step 720. In particular embodiments, the process 700 may be carried out by scanning metadata providing information on various data objects found within the data source used in storing data. For example, the data source may be a database and the various data objects may be the different tables found in the database used for storing data. Here, the metadata may provide information on the various data stored in each of the data objects. For example, the metadata may provide information on the various fields found in a table of a database along with a description of the type of data (values, attributes, and/or the like) stored in the fields. Therefore, the generate metadata process 700 may identify which data fields in the table are used to store targeted data based at least in part on the description of the type of data stored in the fields.

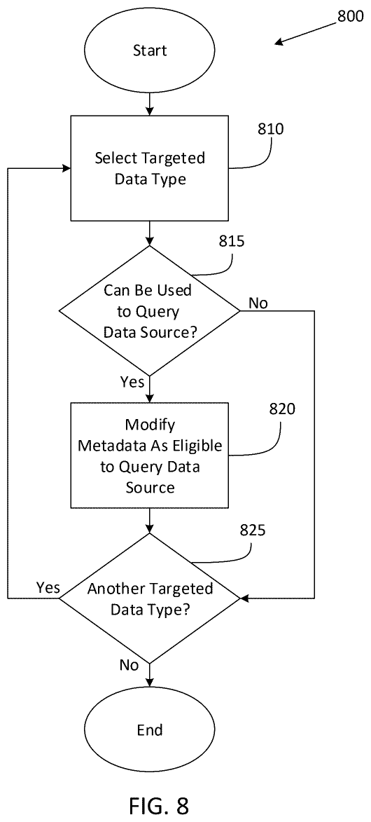

Next, the generate metadata process continues with identifying those targeted data source types that are eligible for use in querying the data source at Step 725. Here, in various embodiments, this step may be carried out via an identify targeted data type process as described in FIG. 8. As detailed further herein, the identify targeted data type process involves identifying those targeted data types found in the data source that may be used (are eligible) for querying data stored in the data source.

In addition, in particular embodiments, the generate metadata process 700 involves generating one or more graph data structures for the data source at Step 730. In particular embodiments, the one or more graph data structures may comprise one or more dependency graphs that represent the different data objects that make up the data source. In some embodiments, each graph data structure may represent a map of where (e.g., locations in a computer memory, data structure, data model, and/or the like) the targeted data types exist in one or more particular data objects. Here, for example, each graph data structure may comprise a graph generated for a graph database that includes nodes for the various data objects, targeted data types, fields for the data objects, and/or the like, with edges connecting the targeted data types, fields, and data objects accordingly. Examples of graph data structures are shown in FIGS. 2, 5, and 6 as previously discussed.

Accordingly, the generate metadata process 700 continues with recording the scanned information (e.g., information on the targeted data types present in the data source) and/or the graph data structures as metadata at Step 735. Note that depending on the embodiment, a graph data structure may be recorded in various formats and is not necessarily recorded in a graphical format. For example, in some embodiments, a graph data structure may be recorded in a data structure such as a vector and/or array that is used to represent the relationships among one or more data objects and targeted data types found for the data source. Further, the scanned information on the targeted data types and graph data structures may be recorded separately in particular embodiments. However, for convenience, the two are described as part of the metadata for the data source.

In addition, in particular embodiments, the generate metadata process 700 may be carried out using artificial intelligence such as one or more machine learning models and/or big data techniques to determine whether two or more data fields found in one or more data objects are used in storing targeted data corresponding to a same type of targeted data. For example, two particular portions of targeted data that are stored in different data fields may have different metadata (e.g., different labels and/or identifiers) and/or may be stored in different formats but may actually represent a same type of targeted data. Here, in some embodiments, the generate metadata process 700 may involve processing one or more features for two or more different data fields using, for example, a machine learning model to generate an indication (e.g., a prediction) as to whether the two or more data fields are used for storing a same or similar targeted data type.

For example, the machine learning model may be a supervised or unsupervised trained model such as a support vector machine or a deep learning model such as a neural network. Accordingly, the machine learning model may process one or more features of the different data fields and generate a likelihood that the different data fields are used in storing targeted data for a same targeted data type. In particular embodiments, the machine learning model may process the features of the different data fields and provide a prediction (e.g., classification) as to whether the different data fields are used for storing data of the same type. For example, looking at FIG. 2, the machine learning model may process one or more features for the data fields “username” 245 and “email” 250 and provide a prediction as to whether the two data fields are used for store targeting data having a same targeted data type, in this case, “Email” 225. Further, the machine learning model may provide a confidence indicator (e.g., value or score) along with the prediction providing a confidence of the prediction that may be used in determining whether the two or more data fields are being used for storing targeted data for a same or similar targeted data type. For example, a determination may be made that the two or more data fields are being used for storing targeted data for a same targeted data type based on the prediction indicating such (e.g., a prediction score over 0.50) and the confidence indicator satisfying a threshold level of confidence (e.g., a confidence score over 0.80).

At this point, the generate metadata process 700 continues with determining whether metadata needs to be generated for another data source at Step 740. If so, the generate metadata process 700 involves returning to Step 715, selecting the next data source, and generating metadata for the newly selected data source as just described. It is noted that although not shown in FIG. 7, the generate metadata process 700 may involve in particular embodiments identifying whether one or more targeted data types identified for a particular data source correspond to one or more targeted data types identified for another data source. For example, similar to recognizing portions of targeted data being directed to a same targeted data type, the generate metadata process 700 may make use of artificial intelligence such as one or more machine learning models and/or big data techniques to identify targeted data types across different data sources that are the same. For example, the generate metadata process 700 may be carried out by processing one or more features of different data fields of data objects found in different data sources using the machine learning model as described above.

### Identify Targeted Data Type

Turning now to FIG. 8, additional details are provided regarding an identify targeted data type process 800 for identifying those targeted data types found in a data source that may be eligible for use in querying the data source in accordance with various embodiments of the disclosure. Accordingly, the process 800 may be implemented in various embodiments as suitable program code executed on computing hardware as described herein.

The identify targeted data type process 800 begins with selecting a targeted data type for the data source at Step 810. For instance, returning to the data source involving the two graph data structures 200, 215 shown in FIG. 2, the identified targeted data types found in the data source for the two data objects 210, 220 include “Email” 225, “FirstName” 230, “LastName” 235, “ssn” 240, and “Address” 270. Therefore, the identify targeted data type process may be carried out by initially selecting the targeted data type “Email” 225 identified for the data source.

Next, the identify targeted data type process 800 continues with performing a determination as to whether the targeted data type can be used to query a data source based on the targeted data type being associated with multiple data elements (e.g., multiple data fields) found in multiple data objects of the data source at Step 815. For example, looking at the targeted data type “Email” 225, this particular targeted data type 225 is associated with fields in both the data object “User” 210 and the data object “UserAddress” 220. Thus, this particular targeted data type 225 would be recognized as eligible to use for querying targeted data from the data source. As a result, the identify targeted data type process 800 would continue with modifying the metadata to identify the targeted data type “Email” 225 as eligible for querying the data source at Step 820.

The identify targeted data type process 800 continues with determining whether another targeted data type is present in the data source at Step 825. If so, then the identify targeted data type process 800 involves returning to Step 810, selecting the next targeted data type for the data source, and determining whether the newly selected targeted data type can be used to query the data source.

As noted, the identify targeted data type process 800 may involve modifying the metadata for the data source to indicate the targeted data types that have been identified as eligible to query the data source. For instance, returning to the example involving the graph data structures 200, 215 shown for the data source in FIG. 2, the identify targeted data type process 800 may be carried out to modify the metadata to identify the targeted data type “Email” 225 as eligible for use in querying targeted data from the data source. For example, in particular embodiments, the targeted data type “Email” 225 may be identified in the metadata as:
targeted_type: Email
“location”: [{“parent”: “schema1”, “object”: “user”, “fields”: [“username, email” ]}]
“location”: [{“parent”: “schema1”, “object”: “user_address”, “fields”: [“username]}]
“queryable”: true

While the targeted data type “FirstName” 230 may be identified in the metadata as:
targeted_type: FirstName
“location”: [{“parent”: “schema1”, “object”: “user”, “fields”: [“first_name” ]}]
“queryable”: false

Therefore, this particular targeted data type 230 is identified in the metadata for the data source as not eligible for use in querying targeted data from the data source.

### Example Technical Platforms

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

Depending on the embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

Depending on the embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### Example System Architecture

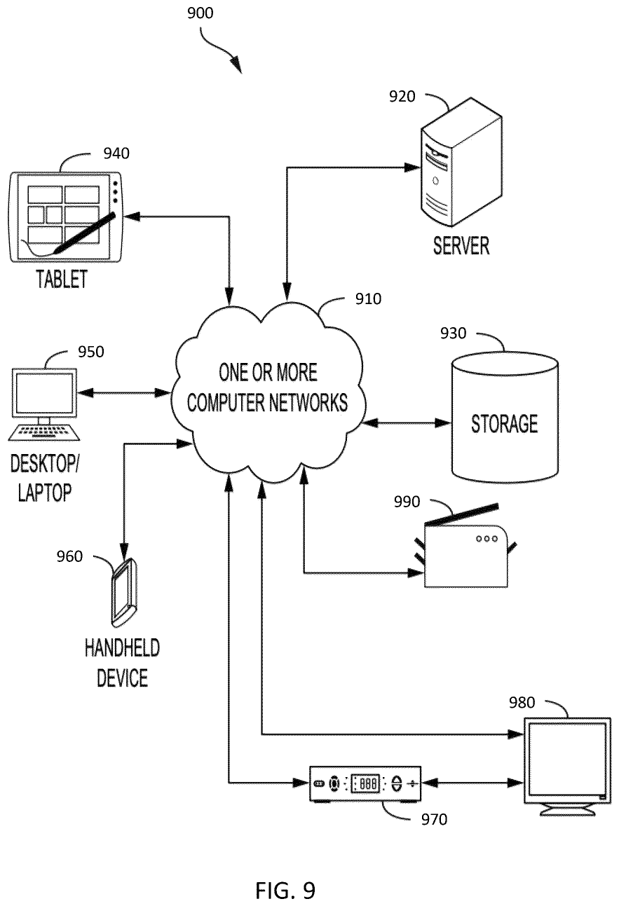

FIG. 9 is a block diagram of a system architecture 900 that may be used in accordance with various embodiments of the disclosure. As may be understood from this figure, the system architecture 900 may include one or more computer networks 910, one or more servers 920, one or more storage devices 930 (that may contain, for example, one or more databases of information), and/or one or more client computing devices such as one or more tablet computers 940, one or more desktop or laptop computers 950, one or more handheld computing devices 960 such as one or more smart phones, one or more browser and Internet capable set-top boxes 970 connected with TVs 980, smart TVs 980 having browser and Internet capability, and/or the like. In particular instances, the client computing device(s) attached to the network(s) 910 may also include devices such as scanners, copiers, printers, fax machines, and/or the like 990 having hard drives (a security risk since copies/prints may be stored on these hard drives). The one or more servers 920, client computing devices, and/or storage devices 930 may be physically located in a same (e.g., central) location, such as the headquarters of an organization, for example, or in separate locations.

In various embodiments, the one or more computer networks 910 facilitate communication between the one or more servers 920, client computing devices, and/or storage devices 930. Here, the one or more computer networks 910 may include any of a variety of types of wired or wireless computer networks such as the Internet, a private intranet, a public switched telephone network (PSTN), or any other type of network. Accordingly, the communication link between the one or more servers 920, client computing devices, and/or storage devices 930 may be, for example, implemented via a Local Area Network (LAN), a Wide Area Network (WAN), the Internet, and/or the like.

### Example Computing Entity

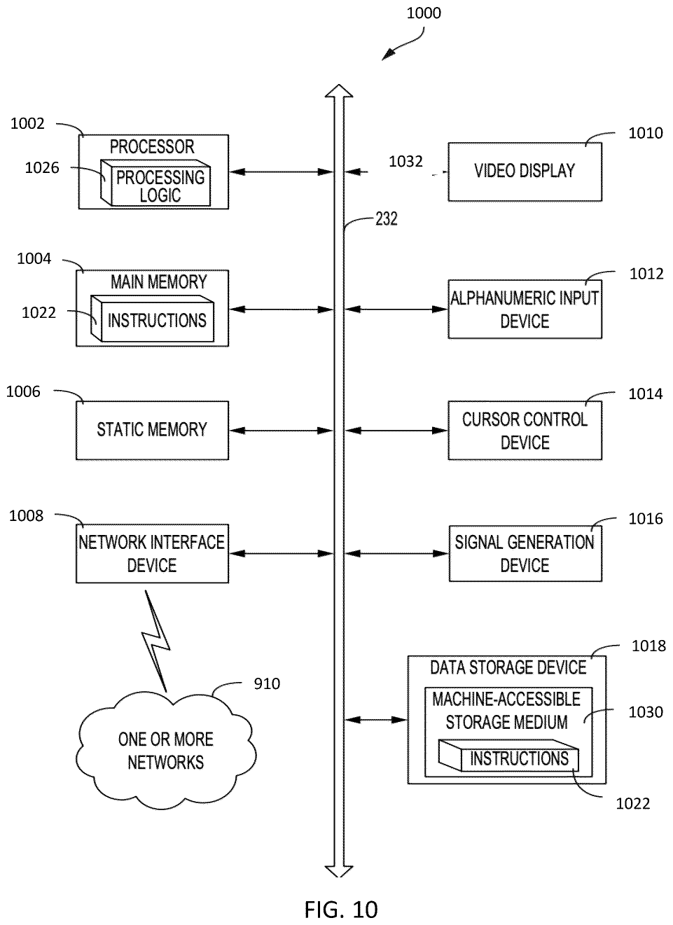

FIG. 10 illustrates a diagrammatic representation of a computing entity 1000 that may be used in accordance with various embodiments of the disclosure. For example, the computing entity 1000 may be computing hardware such as a server 920 and/or a client computing device as described in FIG. 9. In particular embodiments, the computing entity 1000 may be connected (e.g., networked) to one or more other computing entities, storage devices, and/or the like via one or more networks such as, for example, a LAN, an intranet, an extranet, and/or the Internet. As noted above, the computing entity 1000 may operate in the capacity of a server and/or a client device in a client-server network environment, or as a peer computing device in a peer-to-peer (or distributed) network environment. Accordingly, depending the embodiment, the computing entity 1000 may be a personal computer (PC), a tablet PC, a set-top box (STB), a Personal Digital Assistant (PDA), a mobile device (smart phone), a web appliance, a server, a network router, a switch or bridge, or any other device capable of executing a set of instructions (sequential or otherwise) that specify actions to be taken by that device. Further, while only a single computing entity 1000 is illustrated, the term “computing entity” or the like shall also be taken to include any collection of computing entities that individually or jointly execute a set (or multiple sets) of instructions to perform any one or more of the methodologies discussed herein.

An exemplary computing entity 1000 includes a processor 1002, a main memory 1004 (e.g., read-only memory (ROM), flash memory, dynamic random access memory (DRAM) such as synchronous DRAM (SDRAM), Rambus DRAM (RDRAM), and/or the like), a static memory 1006 (e.g., flash memory, static random access memory (SRAM), and/or the like), and a data storage device 218, that communicate with each other via a bus 1032.

The processor 1002 may represent one or more general-purpose processing devices such as a microprocessor, a central processing unit, and/or the like. In some embodiments, the processor 1002 may be a complex instruction set computing (CISC) microprocessor, reduced instruction set computing (RISC) microprocessor, very long instruction word (VLIW) microprocessor, processor implementing other instruction sets, processors implementing a combination of instruction sets, and/or the like. In some embodiments, the processor 1002 may be one or more special-purpose processing devices such as an application specific integrated circuit (ASIC), a field programmable gate array (FPGA), a digital signal processor (DSP), network processor, and/or the like. The processor 1002 may be configured to execute processing logic 1026 for performing various operations and/or steps described herein.

The computing entity 1000 may further include a network interface device 1008, as well as a video display unit 1010 (e.g., a liquid crystal display (LCD), a cathode ray tube (CRT), and/or the like), an alphanumeric input device 1012 (e.g., a keyboard), a cursor control device 1014 (e.g., a mouse), and/or a signal generation device 1016 (e.g., a speaker). The computing entity 1000 may further include a data storage device 1018. The data storage device 1018 may include a non-transitory computer-readable storage medium 1030 (also known as a non-transitory computer-readable storage medium or a non-transitory computer-readable medium) on which is stored one or more sets of instructions 1022 (e.g., software, program) embodying any one or more of the methodologies or functions described herein. The instructions 1022 may also reside, completely or at least partially, within main memory 1004 and/or within the processor 1002 during execution thereof by the computing entity 1000—main memory 1004 and processor 1002 also constituting computer-accessible storage media. The instructions 1022 may further be transmitted or received over a network 910 via the network interface device 1008.

While the computer-readable storage medium 1030 is shown to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding, and/or carrying a set of instructions for execution by the computing entity 1000 and that causes the computing entity 1000 to perform any one or more of the methodologies of the present disclosure. The term “computer-readable storage medium” should accordingly be understood to include, but not be limited to, solid-state memories, optical and magnetic media, and/or the like.

### Exemplary System Operation

The logical steps and/or operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical steps and/or operations described herein are referred to variously as states, operations, steps, structural devices, acts, or modules. These operations, steps, structural devices, acts, and modules may be implemented in software code, in firmware, in special purpose digital logic, and any combination thereof. Greater or fewer steps and/or operations may be performed than shown in the figures and described herein. These steps and/or operations may also be performed in a different order than those described herein.

### CONCLUSION

Although embodiments above are described in reference to a targeted data discovery computational framework, it should be understood that various aspects of the framework described above may be applicable to other types of frameworks, in general.

While this specification contains many specific embodiment details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are described in a particular order, this should not be understood as requiring that such operations be performed in the particular order described or in sequential order, or that all described operations be performed, to achieve desirable results. In certain circumstances, multitasking and parallel processing may be advantageous. Moreover, the separation of various components in the embodiments described above should not be understood as requiring such separation in all embodiments, and it should be understood that the described program components (e.g., modules) and systems may generally be integrated together in a single software product or packaged into multiple software products.

Many modifications and other embodiments of the disclosure will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A method comprising:
receiving a request to identify targeted data for a data subject, the request comprising a first data value of a first data type for the data subject;
determining, by computing hardware, that the targeted data comprises a second data type;
determining, based on a first graph data structure by the computing hardware, that a first data source stores data of the second data type and that the first data source is queryable utilizing a third data type;
determining, based on a second graph data structure by the computing hardware, that a second data source stores data of the first data type and that the second data source is queryable utilizing the first data type;
based on determining that the second data source is queryable utilizing the first data type, querying, by the computing hardware, the second data source utilizing the first data value to retrieve a second data value of the third data type for the data subject;
based on determining that the first data source is queryable utilizing the third data type, querying, by the computing hardware, the first data source utilizing the second data value to retrieve a third data value of the second data type for the data subject; and
performing, by the computing hardware, a targeted data action utilizing the third data value as the targeted data for the data subject.

2. The method of claim 1, further comprising determining that the first data source is not queryable utilizing the first data type.

3. The method of claim 1, wherein performing the targeted data action comprises:
generating a location map for the targeted data that comprises storage locations for the targeted data;
providing the targeted data for display on a graphical user interface of a client device that submitted the request to identify the targeted data for the data subject; or
removing the targeted data from the first data source.

4. The method of claim 1, wherein determining, based on the first graph data structure by the computing hardware, that the first data source stores data of the second data type comprises utilizing a machine learning model to process features of data fields of the first data source to generate a prediction that the data fields are used for storing data of the second data type.

5. The method of claim 4, wherein utilizing the machine learning model to process the features of the data fields of the first data source to generate the prediction that the data fields are used for storing data of the second data type comprises:
utilizing a classification neural network to generate a confidence indicator that the data fields are used for storing data of the second data type; and
determining that the confidence indicator satisfies a threshold level of confidence.

6. The method of claim 1, further comprising:
determining, based on a third graph data structure by the computing hardware, that a third data source stores data of the second data type and that the third data source is queryable utilizing the first data type; and
based on determining that the third data source is queryable utilizing the first data type, querying, by the computing hardware, the third data source utilizing the second data value to retrieve a fourth data value of the second data type for the data subject.

7. The method of claim 6, wherein performing the targeted data action comprises: utilizing the third data value from the first data source and the fourth data value from the third data source as the targeted data for the data subject.

8. A system comprising:
one or more non-transitory computer readable media storing instructions; and
processing hardware configured to cause execute the instructions to perform operations comprising:
receiving a request to identify targeted data for a data subject, the request comprising a first data value of a first data type for the data subject;
determining, by computing hardware, that the targeted data comprises a second data type;
determining, by the computing hardware, that a first data source stores data of the second data type and that the first data source is queryable utilizing a third data type;
determining, by the computing hardware, that a second data source stores data of the first data type and that the second data source is queryable utilizing the first data type;
based on determining that the second data source is queryable utilizing the first data type, querying, by the computing hardware, the second data source utilizing the first data value to retrieve a second data value of the third data type for the data subject;
based on determining that the first data source is queryable utilizing the third data type, querying, by the computing hardware, the first data source utilizing the second data value to retrieve a third data value of the second data type for the data subject; and
performing, by the computing hardware, a targeted data action utilizing the third data value as the targeted data for the data subject.

9. The system of claim 8, wherein the operations further comprise generating metadata for the first data source by:
determining that the third data type is eligible to query the first data source in response to scanning a plurality of data types comprising the first data type, the second data type, and the third data type in the first data source; and
generating the metadata of the first data source to include the third data type within a set of known queryable data types for the first data source.

10. The system of claim 9, wherein the operations further comprise:
determining that the first data type is not eligible to query the targeted data from the first data source; and
excluding the first data type from the set of known queryable data types for the first data source from the metadata.

11. The system of claim 10, wherein the operations further comprise:
determining that the set of known queryable data types from the metadata of the first data source does includes a third data type; and
in response to determining that the third data type is eligible to query the first data source, modifying the metadata to include the third data type in the set of known queryable data types.

12. The system of claim 9, wherein the operations further comprise:
determining that a new field corresponding to an additional data type is added to a first graph data structure for the first data source after generation of the metadata for the first data source;
determining that the additional data type is eligible to query the targeted data from the first data source in response to detecting the additional data type in an additional graph data structure of an additional data object in the first data source; and
modifying the metadata of the first data source to include the additional data type within the set of known queryable data types for the first data source.

13. The system of claim 8, wherein performing the targeted data action comprises:
generating a location map for the targeted data that comprises storage locations for the targeted data;
providing the targeted data for display on a graphical user interface of a client device that submitted the request to identify the targeted data for the data subject; or
removing the targeted data from the first data source.

14. The system of claim 8, wherein determining, by the computing hardware, that the first data source stores data of the second data type comprises utilizing a machine learning model to process features of data fields of the first data source to generate a prediction that the data fields are used for storing data of the second data type.

15. The system of claim 14, wherein utilizing the machine learning model to process the features of the data fields of the first data source to generate the prediction that the data fields are used for storing data of the second data type comprises:
utilizing a classification neural network to generate a confidence indicator that the data fields are used for storing data of the second data type; and
determining that the confidence indicator satisfies a threshold level of confidence.

16. A non-transitory computer readable medium comprising instructions that, when executed by processing hardware, cause the processing hardware to perform operations comprising:
receiving a request to identify targeted data for a data subject, the request comprising a first data value of a first data type for the data subject;
determining, by computing hardware, that the targeted data comprises a second data type;
determining, based on a first graph data structure by the computing hardware, that a first data source stores data of the second data type and that the first data source is queryable utilizing a third data type;
determining, based on a second graph data structure by the computing hardware, that a second data source stores data of the first data type and that the second data source is queryable utilizing the first data type;
based on determining that the second data source is queryable utilizing the first data type, querying, by the computing hardware, the second data source utilizing the first data value to retrieve a second data value of the third data type for the data subject;
based on determining that the first data source is queryable utilizing the third data type, querying, by the computing hardware, the first data source utilizing the second data value to retrieve a third data value of the second data type for the data subject; and
performing, by the computing hardware, a targeted data action utilizing the third data value as the targeted data for the data subject.

17. The non-transitory computer readable medium of claim 16, wherein the operations further comprise determining that the first data type is eligible for querying the second data source by:
accessing a set of known queryable data types for the second data source from metadata of the second data source; and
determining that the set of known queryable data types comprises the first data type.

18. The non-transitory computer readable medium of claim 17, wherein the operations further comprise:
determining that the set of known queryable data types from the metadata of the second data source does not include the second data type; and
in response to determining that the second data type is ineligible to query the second data source, modifying the metadata to exclude the second data type in the set of known queryable data types.

19. The non-transitory computer readable medium of claim 16, wherein determining, by the computing hardware, that the first data source stores data of the second data type comprises utilizing a machine learning model to process features of data fields of the first data source to generate a prediction that the data fields are used for storing data of the second data type.

20. The non-transitory computer readable medium of claim 19, wherein utilizing the machine learning model to process the features of the data fields of the first data source to generate the prediction that the data fields are used for storing data of the second data type comprises:
utilizing a classification neural network to generate a confidence indicator that the data fields are used for storing data of the second data type; and
determining that the confidence indicator satisfies a threshold level of confidence.
